(19) United States
(12) Patent Application Publication
(10) Pub. No.: US 2010/0238101 A1
(43) Pub. Date: Sep. 23, 2010

(54) IMAGE PROCESSING METHOD CAPABLE OF REDUCING COLOR SHIFT

(76) Inventors: Long-Cai Jhuo, Taipei County (TW); Kuei-Wei Huang, Taipei City (TW); Yi-Cheng Tsai, Taoyuan County (TW); Po-Chiang Huang, Tainan County (TW)

Correspondence Address: NORTH AMERICA INTELLECTUAL PROPERTY CORPORATION, P.O. BOX 506, MERRIFIELD, VA, 22116, US

(21) Appl. No.: 12/491,255

(22) Filed: Jun. 25, 2009

(30) Foreign Application Priority Data
Mar. 23, 2009 (TW) 098109402

(51) Int. Cl. G09G 3/36

(52) U.S. Cl. 345/88

(57) ABSTRACT

An image-processing method adjusts the gamma characteristic of an LCD device based on the difference between color coordinates of an image when viewed directly in front of the LCD device and at an angle. Therefore, color characteristics of the image are substantially the same when viewed directly in front of the LCD device and at an angle.

### BACKGROUND OF THE INVENTION

1. Field of the Invention

The present invention provides an image-processing method, and more particularly, to an image-processing method capable of reducing color shift.

2. Description of the Prior Art

Liquid crystal display (LCD) devices, characterized in low radiation, small size and low power consumption, have gradually replaced traditional cathode ray tube (CRT) devices and are widely used in various electronic products, such as notebook computers, personal digital assistants (PDAs), flat-panel TVs, or mobile phones.

The deflection index of light varies with viewing angle since the light beams with different incident angles result in different degrees of retardation in the liquid crystal layer. Thus, LCD devices provide different degrees of light penetration when viewed directly in front and at an angle. Normally, color tracking is performed so that an LCD device can achieve the best display effect for viewings directly in front. However, due to the variations in light brightness caused by different viewing angles, different color components of the light (such as the red light, the green light and the blue light) are respectively mixed with different ratios. The deviation of the display effects when viewed directly in front and viewed at an angle is known as “color shift”. Various methods are employed to reduce color shift in order to provide a wide range of viewing angles with high display quality.

Reference is made to FIG. 1 for a characteristic curve of an LCD device when viewed directly in front. In FIG. 1, the horizontal axis represents gray scale, the vertical axis represents light penetration rate, and R, G, B respectively represent the red, green and blue primary colors when viewed directly in front. In the prior art, color shift correction is normally performed on two of the primary colors only. For example, the gray scales of the blue and green colors with larger amounts of color shift are converted, while the red color retains its original gray scale. After performing color tracking, each of the RGB primary colors can be adjusted to possess optimized characteristic curves so that the LCD device can provide the best display quality.

Reference is made to FIG. 2 for a characteristic curve of an LCD device when viewed at an angle. In FIG. 2, the horizontal axis represents gray scale, the vertical axis represents light penetration rate, and R′, G′, B′ respectively represent the red, green and blue primary colors when viewed at an angle. Since the deflection index of light varies with viewing angles, different colors have different light penetration rates when viewed directly in front and at an angle even when having the same gray scale. As depicted in FIG. 2, the difference between the front-view and angle-view light penetration rates is small when the gray scale is near 0 or 255, but a large deviation occurs in the middle-range gray scales (around 100-150). Since the R′, G′, B′ characteristic curves associated with angle-view images are not optimized, color mixing may not be accurate and the LCD device may display more “reddish” images when viewed at an angle.

U.S. Pat. No. 6,661,488 “Vertically-aligned (VA) liquid crystal display device” discloses a method for reducing color shift between front-view and angle-view images of an LCD device. In this prior art, the manufacturing process is modified so that each red, green and blue pixels have different sizes while the thickness of the liquid crystal layer remains unchanged. Resin layers disposed on each type of color layers also vary so that each red, green and blue pixels have different cell gaps for reducing color shift. However, since the deposition of resin layers on the color layers requires extremely high accuracy which makes the manufacturing process very complicated and difficult to control, the manufacturing costs may be largely increased or the production yield may drop drastically.

US. Publication No. 2006/0215081 “Vertically aligned mode liquid crystal display with differentiated B cell gap” discloses another method for reducing color shift between front-view and angle-view images of an LCD device. In this prior art, the manufacturing process is modified so that each red, green and blue color layers have different thickness and each red, green and blue pixels have different cell gaps for reducing color shift. However, varying the thickness of each color layer may result in low color saturation or insufficient light penetration.

The prior art LCD device reduces color shift by modifying the manufacturing process. Complicated process may raise manufacturing costs or lower production yield. Insufficient light penetration may also lower the display quality of the LCD device.

### SUMMARY OF THE INVENTION

The present invention provides an image-processing method capable of reducing color shift comprising generating a predetermined image based on a predetermined gamma characteristic; measuring a first color coordinate of the predetermined image when viewed directly in front; measuring a second color coordinate of the predetermined image when viewed at an angle; generating a corrected gamma characteristic by adjusting the predetermined gamma characteristic based on a difference between the first and second color coordinates; generating a corrected image based on the corrected gamma characteristic; and determining whether a first color characteristic of the corrected image when viewed directly in front and a second color characteristic of the corrected image when viewed at an angle are substantially the same.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a characteristic curve of an LCD device when viewed directly in front.

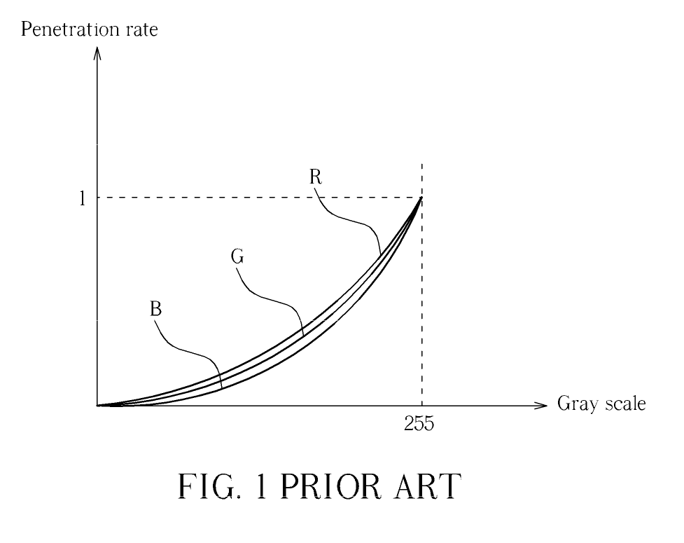

FIG. 2 is a diagram illustrating a characteristic curve of an LCD device when viewed at an angle.

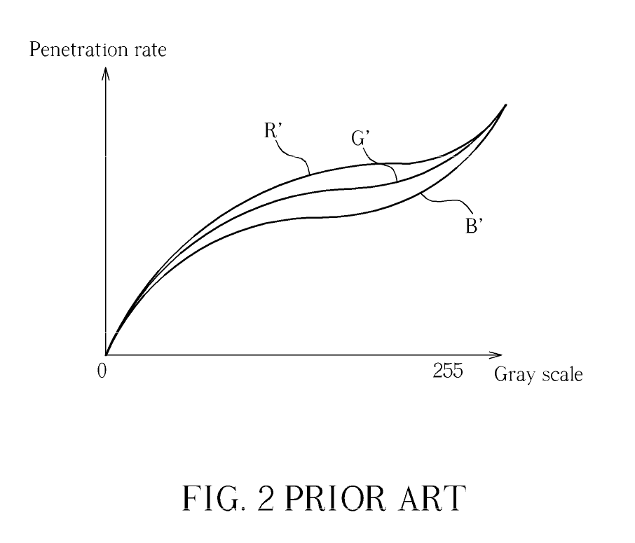

FIG. 3 is a diagram illustrating a color-adjusting method according to the present invention.

FIG. 4 is a diagram illustrating the characteristic curves of images when driving the LCD device with the corrected gamma characteristic and viewed at an angle.

FIG. 5 is a flowchart illustrating an image-processing method according to a first embodiment of the present invention.

FIG. 6 is a flowchart illustrating an image-processing method according to a second embodiment of the present invention.

### DETAILED DESCRIPTION

A color space is an abstract mathematical model which uses a set of values (usually 3 or 4 values) or color components to represent a color. In digital image-processing, the most commonly used is the RGB color space which processes the RGB primary colors using respective color channels. Depending on the capability of equipment, there are many ways to implement the RGB color space. A standard display device normally adopts a 24-bit scheme in which the red color channel R, the green color channel G and the blue color channel B each can provide 8-bit gray scales or 256 sets of gray scale data in total. By mixing the gray scales provided by all three color channels, images can be represented by 24-bit true colors (224 distinct colors). For example, if the color channel values (R, G, B) used for driving an LCD device are (255, 0, 0), (0, 255, 0), (0, 0, 255) and (255, 255, 255), the LCD device can display pure red, pure green, pure blue and pure white images, respectively.

The RGB tristimulus values represent the amounts of the three RGB primary colors in a three-component additive color model needed to match that test color. In colorimetry, three tristimulus values (X, Y, Z), which simulate human visual perception, are converted into color coordinates for ease of usage, such as a CIE color space. The (x, y, z) color coordinates of the CIE color space reflect the ratios of the three primary colors with respect to the RGB tristimulus values, as well as the common characteristics of colors having identical chromance but different luminances. The conversion between different types of color coordinates is well-known to those skilled in the art. The (x, y, z) color coordinates of the CIE color space are merely an embodiment and do not limit the scope of the present invention.

The color channel values (R, G, B) and the CIE (x, y, z) color coordinates are reversely convertible. If 256 sets of color channel values (255, 255, 255), (254, 254, 254), . . . and (0, 0, 0) are used for driving an LCD device, the resultant CIE (x, y, z) color coordinates of 256 gray scales are represented by (x₂₅₅, y₂₅₅, z₂₅₅), (x₂₅₄, y₂₅₄, z₂₅₄), and (x₀, y₀, z₀), respectively. The relationship between the color channel values and the color coordinates is known as the gamma characteristic of the LCD device. As mentioned before, color tracking is performed under the condition that the LCD device is viewed directly in front. Therefore, perfectly-matched images when viewed directly in front result in deviated color coordinates when viewed at an angle due to color shift. In the present invention, a predetermined gamma characteristic is first applied to the LCD device for measuring the color coordinates (x, y, z) of an image when viewed directly in front and the color coordinates (x′, y′, z′) of the image when viewed at an angle. Next, a corrected gamma characteristic is generated by adjusting the predetermined gamma characteristic based on the difference between the color coordinates (x, y, z) and (x′, y′, z′). By driving the LCD device with the corrected gamma characteristic, it can be determined whether the color shift has been reduced.

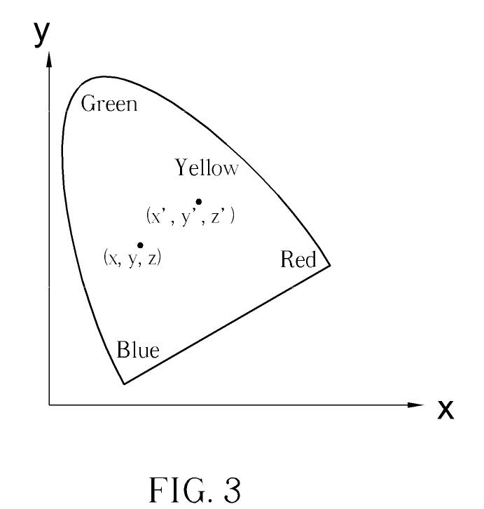

Reference is made to FIG. 3 for a diagram illustrating a color-adjusting method according to the present invention. FIG. 3 shows a CIE color space chromaticity diagram including a “gamut” represents all of the chromaticities visible to the average person. The gamut of all visible chromaticities on the CIE plot is the tongue-shaped or horseshoe-shaped figure, in which red, yellow, green, blue and white colors are located at respective regions as depicted in FIG. 3. Due to color shift when viewed at an angle, the color coordinates (x, y, z) and (x′, y′, z′) on the CIE plot do not match each other. The present invention can adjust the predetermined gamma characteristic based on the difference between the color coordinates (x, y, z) and (x′, y′, z′).

In an embodiment of the present invention, the red color component of the color coordinates (x′, y′, z′) can be adjusted. For example, the red color channel value R can be adjusted from an original range of 0-255 to a new range 0-240. In other words, the original color coordinates x₂₄₀ corresponding to the red color channel value R=240 is used as the new color coordinates x₂₅₅′ corresponding to the red color channel value R=255, and new color coordinates x₀′-x₂₅₅′ can be obtained based on the original red color coordinates x₀-x₂₄₀. In another embodiment of the present invention, the other color components of the color coordinates (x′, y′, z′) can be adjusted. For example, the blue color channel value B can be adjusted from an original range of 0-255 to a new range 0-230. In other words, the original color coordinates z₂₃₀ corresponding to the blue color channel value B=230 is used as the new color coordinates z₂₅₅′ corresponding to the blue color channel value B=255, and new color coordinates z₀′-z₂₅₅′ can be obtained based on the original blue color coordinates z₀-z₂₃₀.

In order to determine whether the color shift has been reduced, the LCD device is driven with the corrected gamma characteristic. After measuring the current color coordinates (x′, y′, z′) when viewed at an angle, it can then be determined whether the difference between the color coordinates (x, y, z) and (x′, y′, z′) can be reduced.

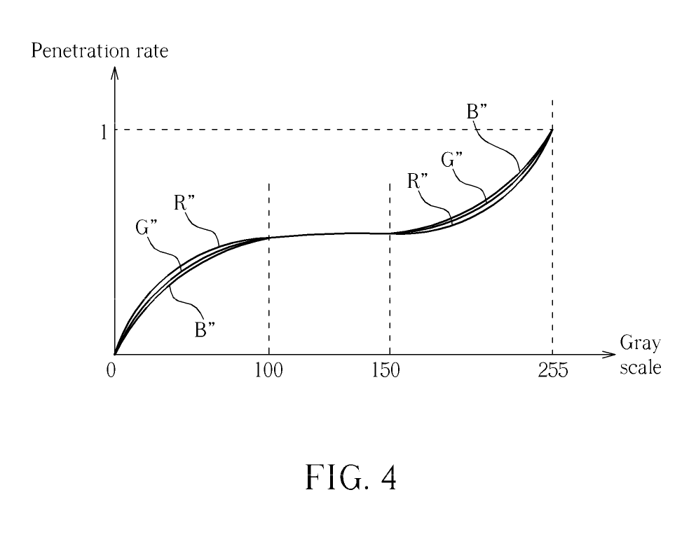

Or, after driving the LCD device with the corrected gamma characteristic, the present invention can measure the characteristic curve illustrating the relationship between the penetration rate and the gray scale of images when viewed at an angle. It can then be determined whether the characteristic curves of the three primary colors are matched. Reference is made to FIG. 4 for the characteristic curves of images when driving the LCD device with the corrected gamma characteristic and viewed at an angle. In FIG. 4, the horizontal axis represents gray scale, the vertical axis represents light penetration rate, and R″, G″, B″ respectively represent the characteristic curves of the red, green and blue primary colors when viewed at an angle. In the present invention, the characteristic curves of the red, green and blue primary colors can be optimized so that these curves are matched at low gray scales, high gray scales and middle-range gray scales (around 100-150). Therefore, color shift due to variations in viewing angles can be reduced.

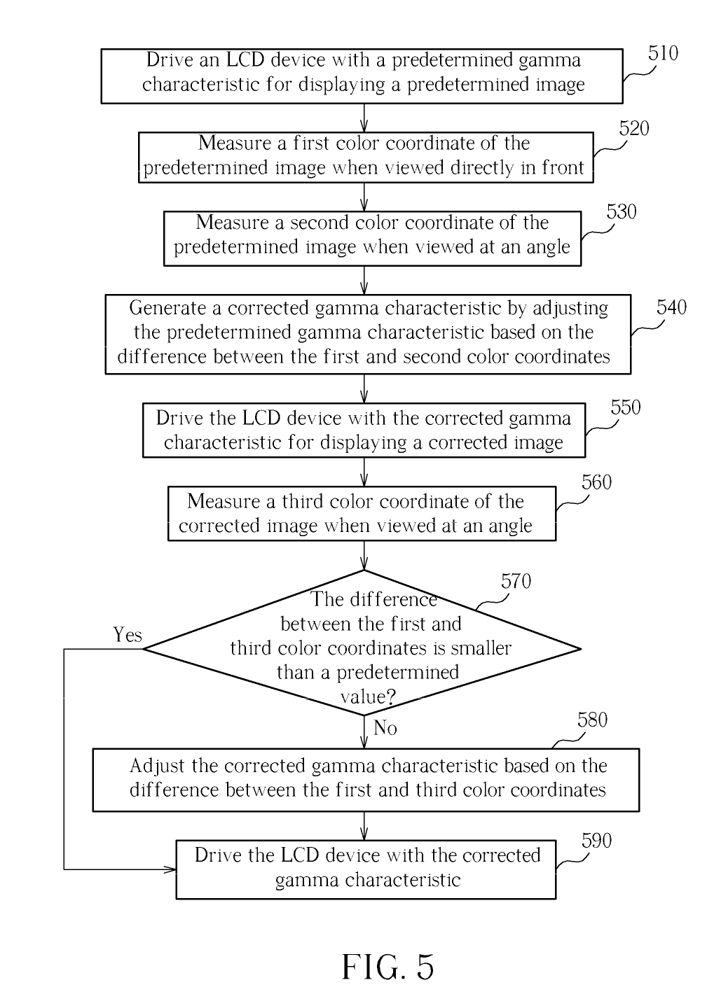

Reference is made to FIG. 5 for a flowchart illustrating an image-processing method according to a first embodiment of the present invention. The flowchart in FIG. 5 includes the following steps:

Step 510: drive an LCD device with a predetermined gamma characteristic for displaying a predetermined image;

Step 520: measure a first color coordinate of the predetermined image when viewed directly in front;

Step 530: measure a second color coordinate of the predetermined image when viewed at an angle;

Step 540: generate a corrected gamma characteristic by adjusting the predetermined gamma characteristic based on the difference between the first and second color coordinates;

Step 550: drive the LCD device with the corrected gamma characteristic for displaying a corrected image;

Step 560: measure a third color coordinate of the corrected image when viewed at an angle;

Step 570: determine whether the difference between the first and third color coordinates is smaller than a predetermined value; if the difference between the first and third color coordinates is smaller than the predetermined value, execute step 590; if the difference between the first and third color coordinates is not smaller than the predetermined value, execute step 580;

Step 580: adjust the corrected gamma characteristic based on the difference between the first and third color coordinates; execute step 550;

Step 590: drive the LCD device with the corrected gamma characteristic.

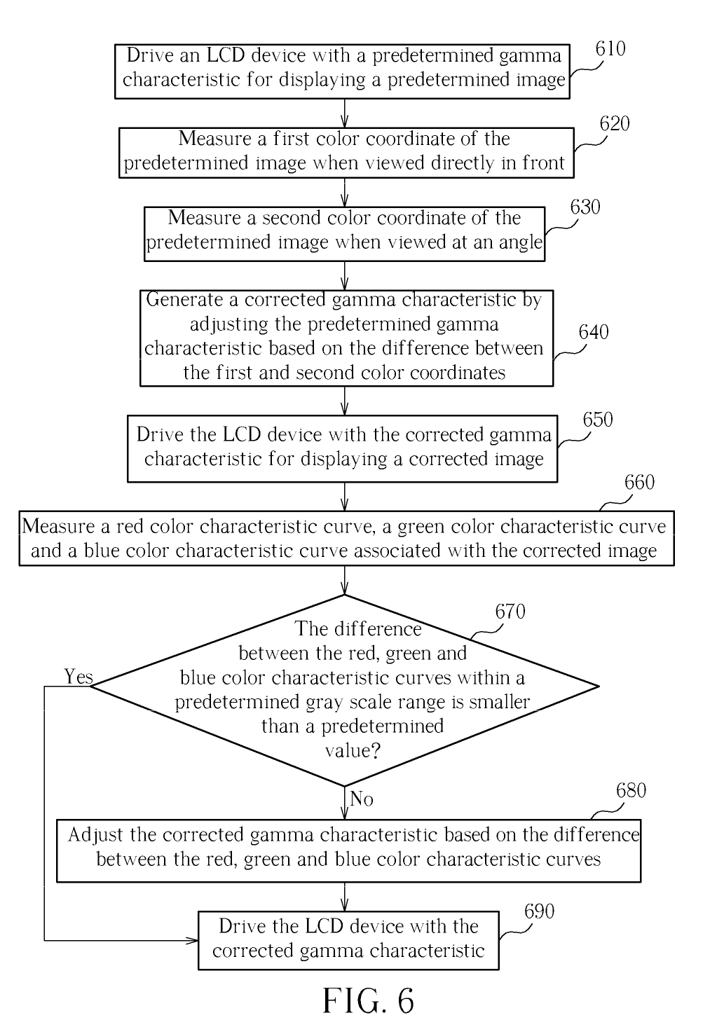

Reference is made to FIG. 6 for a flowchart illustrating an image-processing method according to a second embodiment of the present invention. The flowchart in FIG. 6 includes the following steps:

Step 610: drive an LCD device with a predetermined gamma characteristic for displaying a predetermined image;

Step 620: measure a first color coordinate of the predetermined image when viewed directly in front;

Step 630: measure a second color coordinate of the predetermined image when viewed at an angle;

Step 640: generate a corrected gamma characteristic by adjusting the predetermined gamma characteristic based on the difference between the first and second color coordinates;

Step 650: drive the LCD device with the corrected gamma characteristic for displaying a corrected image;

Step 660: measure a red color characteristic curve, a green color characteristic curve and a blue color characteristic curve associated with the corrected image;

Step 670: determine whether the difference between the red, green and blue color characteristic curves within a predetermined gray scale range is smaller than a predetermined value; if the difference is smaller than the predetermined value, execute step 690; if the difference is not smaller than the predetermined value, execute step 680;

Step 680: adjust the corrected gamma characteristic based on the difference between the red, green and blue color characteristic curves; execute step 650;

Step 690: drive the LCD device with the corrected gamma characteristic.

In the above-mentioned embodiments of the present invention, the red and blue color components of the color coordinates (x′, y′, z′) are adjusted so that the red color channel value R and the blue color channel value B can be adjusted from an original range of 0-255 to new ranges 0-240 and 0-230, respectively. However, a single color component or more color components of the color coordinates (x′, y′, z′) can be adjusted simultaneously in the present invention.

The present invention adjusts the gamma characteristic of the LCD device based on the difference between the color coordinates of an image when viewed directly in front and at an angle. Therefore, the LCD device can display images having substantially identical color characteristics when viewed directly in front and at an angle, thereby providing a wide viewing angle and high display quality.

Those skilled in the art will readily observe that numerous modifications and alterations of the device and method may be made while retaining the teachings of the invention.

What is claimed is:

1. An image-processing method capable of reducing color shift comprising:
generating a predetermined image based on a predetermined gamma characteristic;
measuring a first color coordinate of the predetermined image when viewed directly in front;
measuring a second color coordinate of the predetermined image when viewed at an angle;
generating a corrected gamma characteristic by adjusting the predetermined gamma characteristic based on a difference between the first and second color coordinates;
generating a corrected image based on the corrected gamma characteristic; and
determining whether a first color characteristic of the corrected image when viewed directly in front and a second color characteristic of the corrected image when viewed at an angle are substantially the same.

2. The image-processing method of claim 1 further comprising:
driving a display device based on the corrected gamma characteristic when the first and second color characteristics are substantially the same.

3. The image-processing method of claim 1 further comprising:
adjusting the corrected gamma characteristic based on a difference between the first and second color characteristics of the corrected image when the first and second color characteristics are not substantially the same.

4. The image-processing method of claim 1 determining whether when the first and second color characteristics are substantially the same comprises:
measuring a third color coordinate of the corrected image when viewed at an angle; and
determining whether a difference between the first and third color coordinates is smaller than a predetermined value.

5. The image-processing method of claim 1 wherein whether when the first and second color characteristics are substantially the same comprises:
measuring a red color characteristic curve, a blue color characteristic curve and a blue color characteristic curve of the corrected image when viewed at an angle; and
determining whether the red color, the blue color and the blue color characteristic curves are matched.

6. The image-processing method of claim 5 wherein the red color characteristic curve includes a relationship between a penetration rate and a gray scale of red light when the corrected image is viewed at an angle, the green color characteristic curve includes a relationship between a penetration rate and a gray scale of green light when the corrected image is viewed at an angle, and the blue color characteristic curve includes a relationship between a penetration rate and a gray scale of blue light when the corrected image is viewed at an angle.

7. The image-processing method of claim 5 wherein determining whether the red color, the blue color and the blue color characteristic curves are matched comprises:
determining whether the red color, the blue color and the blue color characteristic curves are matched in a predetermined gamma range.

8. The image-processing method of claim 1 wherein generating the corrected gamma characteristic comprises:
adjusting a relationship between a color channel value and a color coordinate.

9. The image-processing method of claim 1 wherein generating the corrected gamma characteristic comprises:
adjusting relationships between corresponding color channel values of a plurality of color channels and corresponding color coordinates.
